(19) United States
(12) Patent Application Publication
(10) Pub. No.: US 2002/0090140 A1
(43) Pub. Date: Jul. 11, 2002

(54) Method and apparatus for providing clinically adaptive compression of imaging data

(76) Inventor: Graham Thirsk, Everett, WA (US)

Correspondence Address: Connex MD, Inc., P. O. Box 30577, Seattle, WA, 98103-0577, US

(21) Appl. No.: 09/923,783

(22) Filed: Aug. 6, 2001

Related U.S. Application Data
(60) Provisional application No. 60/222,952, filed on Aug. 4, 2000.

(51) Int. Cl. G06K 9/00

(52) U.S. Cl. 382/239; 382/243; 382/128

(57) ABSTRACT

A system and method for clinical adaptive compression of image data is disclosed. Images are examined for contextual data, color/grayscale data, color/grayscale table, interpolated data, temporal redundancy, display mode, and/or other information. One or more subregions of data is identified, simplified, and compressed without degrading the quality of the clinically important information. The less clinically important information is more highly compressed. Redundant and non-essential data may be decimated, and the clinically necessary information is coded and made available for access.

### CROSS-REFERENCE TO RELATED APPLICATION

The present application claims the benefit of U.S. Provisional Application No. 60/222,952 filed Aug. 4, 2000.

### FIELD OF THE INVENTION

This invention relates to image data compression schemes and more particularly to a system and method for compressing image data that will facilitate remote access to medical or other information by enabling the transfer of high-bandwidth data streams without loss of critical information.

### BACKGROUND OF THE INVENTION

There is increasing awareness of the economic and clinical advantages to be gained by using a centralized group of “expert” clinicians to review and interpret medical or other images acquired at a remote location. By way of example, an emergency response technician, a battlefield medic, or a trauma physician may obtain medical images of a patient and may need another expert reviewer at a remote site to review the images. A major challenge to providing this remote clinical capability is the transfer of high bandwidth continuous data streams without loss of critical clinical information.

Current communications infrastructure barely meets the bandwidth requirements for real-time image streams and the costs are considerable. Substantial reduction in data rates, without loss of clinically significant data, is desirable if lower cost, reduced bandwidth, and communication paths such as Digital Subscriber Lines (DSL) or Integrated Services Digital Network (ISDN) are to be used. As illustrated in Table 1 below, various connectivity mediums are disclosed, with transmission times ranging from 15 minutes to over 3 hours for certain clinical data files. These times may be too large to provide time effective communication of data.

TABLE 1
Comparison of Data Transmission Seeds

| | Band- | Band- | | |
|---|---|---|---|---|
| Connec- | width | width | Time to Transmit | Time to Transmit |
| tivity | (Kbits/ | (Kbytes/ | 1 sec of Ultrasound | 1 sec of Cine- |
| Medium | sec) | sec) | (27 Mbytes) | Angio (60 Mbytes) |
| 56K | 56 | 7 | 64 minutes | >3 hours |
| Modem | | | | |
| ISDN | 128 | 16 | 28 minutes | >1 hour |
| DSL | 384 | 24 | 18 minutes | 54 minuets |
| ADSL | 768 | 48 | 9 minutes | 27 minutes |
| T1 | 1500 | 94 | 4.8 minutes | 15 minutes |

Many compression/decompression (codecs) methods are block-oriented. That is, they work by first dividing an image into regular blocks, usually 8×8 pixels square. Each block is examined for uniformity. If it is uniform, the block is encoded as-is. If it is not uniform, it is further subdivided. This block-orientation may lead to the blocky-pixel appearance when the codec breaks down. Codecs mainly differ in how the blocks are encoded.

One example is the Joint Photographic Experts Group standard IS 10918-1 (ITU-T T.81), commonly referred to as JPEG, which defines a lossy, block-oriented compression method, using the discrete cosine transform (DCT) to perform the compression. It was developed specifically to compress continuous-tone photographic images. Compression can be accomplished in real-time.

The algorithm effects the compression by separation of the luminance and chrominance parts of the image using YUV color space, analysis of this color space and reduction of chrominance levels, DCT image coding, quantization of the coded image, which determines the lossiness, and final coding, which maximizes the homogeneity of the data. Lossless JPEG compression replaces the DCT coding and quantization with modified Huffman encoding (i.e., coding where the complete set of codes may be represented as a binary tree called a Huffman tree). Performing the Huffman coding in YUV (where Y is luminance, U is red minus, and V is blue minus), color space improves the compression rates over other lossless compression methods. Motion JPEG, or M-JPEG, refers to a video adaptation of the JPEG standard for the streaming of still photos. It simply treats a video stream as a series of still photos, compressing each individually, with no inter-frame compression. Because it uses no inter-frame compression, it is ideal for editing, as arbitrary cuts are not complicated by the loss of key frames.

Based on the work of the Motion Picture Experts Group (MPEG), a joint committee of the International Organization for Standardization (ISO), and the International Electrotechnical Commission (IEC), MPEG codecs enjoy widespread acceptance and support. The MPEG-1 standard defines a coding designed to deliver 30 fields per second video from bandwidth-limited sources such as CD-ROM. MPEG-1 is a lossy, block-oriented compression method using DCT to do the compression, and uses both spatial and temporal compression. MPEG-1 differs from other codecs in the way that it performs inter-frame compression. As with other codecs, MPEG-1 uses key frames—called I-frames in MPEG—that contain all of the information for the frame; but MPEG then uses two different types of inter-frame compression. The first, called P-frames, are frames that are based on past frames with only the differences encoded, the traditional method of doing temporal compression. However, the second, called B-frames, are bi-directionally encoded based on both past and future frames in the video stream. These B-frames can be very highly compressed because they are based on the information contained in two other frames, making the differences, which must be encoded quite small.

MPEG-1 was designed to use a frame size of 352×240 pixels, with each pixel horizontally and vertically doubled during playback yielding a grainy picture, charitably called “VHS-quality.” However, as with many standards, people have taken it on themselves to “expand” the standard to encode 640×480 pixel frames. By using such nonstandard changes, MPEG-1 has been extended well beyond its original CD-ROM playback origins to be used as the basis of some of the current Digital Broadcast System (DBS) satellite television systems.

While both compression and decompression of MPEG-1 is possible in software, it was designed to use special-purpose hardware. To achieve the highest quality of MPEG-1 compression, a lot of hardware horsepower must be used, making compression an expensive proposition. Playback can be done with lower-cost, consumer-level hardware. With the increasing computing power of personal computers (PCs), software-only playback of MPEG-1 has become common. While some vendors are experimenting with using MPEG-1 hardware in editing systems, in general, MPEG-1 is considered a delivery system and not an editing system, due to the high level of inter-frame compression.

The MPEG-2 standard was designed to build on the MPEG-1 standard and be used in high-bandwidth applications such as satellite delivery. MPEG-2 delivers 60 field-per-second video at full Center for Communication Interface Research CCIR 601 resolution. MPEG-2 requires special high-speed hardware for compression and playback. Real-time compression of MPEG-2 is not yet generally available, requiring all video to be pre-compressed. This is a major stumbling block to its use in systems that must cover live events. Further, as with MPEG-1, MPEG-2 is not well suited to editing applications.

Another type of compression is fractal compression, which is based on the patented work of Dr. Michael Barnsley. Fractal compression offers the advantage of being resolution independent. In theory, an image can be scaled up without loss of resolution. Like many of the other codecs, fractal compression is block oriented. But rather than representing similar blocks in a look-up dictionary, fractal compression represents them as mathematical (fractal) equations.

Fractal compression is highly asymmetric because determining the mathematical equations is very computer intensive. However, decoding the image for display is very fast. While there may be promise in fractal compression, it has yet to gain significant use.

Another type of compression technology is wavelet compression. In general terms, wavelet compression performs compression by breaking each frame apart based on frequency. This allows it to preserve high-frequency information (edges, fine detail, etc.) using a lower level of compression, while compressing lower-frequency content to a greater degree. Wavelet compression is symmetric, compressing and decompressing quite quickly. Although wavelet compression results in a higher quality of image than JPEG for a given compression, there are still blocking artifacts at compression levels above 15:1 that may interfere with interpretation of medical images.

The most widely used compression method for medical or other clinical analytic or diagnostic images is JPEG. The Digital Imaging and Communications in Medicine (DICOM) standard for medical image exchange, currently only specifies JPEG compression. MPEG has also been used to compress clinical image streams, such as echocardiography and angiography exams. However, MPEG requires considerable computational power, making hardware for real-time video compression still very expensive.

While both these methods can achieve high compression ratios, and still produce adequate broadcast video quality, the decimation of the image data may result in loss of critical clinical information because the determination of which data to discard is not based upon critical, clinical relevance. There has, been much discussion concerning the potential loss of critical clinical information during the decimation process.

Several early studies attempted to determine clinically acceptable compression rates for clinical images. JPEG compression at up to 20:1 and MPEG compression up to 40:1 was deemed to be acceptable. However, more recent studies suggest that clinical error rates may be adversely affected by lossy compression.

A recent study at the Mayo Clinic concluded that both JPEG compression and wavelet compression of ultrasound images at compression rates greater than 12:1 resulted in loss of clinical quality, as determined by a panel of expert reading physicians. Another study published in the Journal of the American College of Cardiology and the British Heart Journal concluded that JPEG compression of angiography images at rates greater than 16:1 produced a 30% increase in the error rate for detection of calcification compared to uncompressed images.

Commercial products that use one or more compression techniques are fairly widespread. One commercial venture has FDA 510k approval for the use of MPEG compression for transmission and storage of ultrasound image streams and another has approval for a wavelet compression methods. However, given the concern about clinical accuracy when using lossy compression, these devices are less than ideal.

### SUMMARY OF THE INVENTION

It is an object of the invention to overcome these and other drawbacks of present systems and methods.

It is another object of the invention to provide a system and process for enabling clinically adaptive compression of image data.

It is another object of the invention to provide a system and process for compression of clinical data without loss of critical information.

In an embodiment of the present invention, the clinical image data is divided into a first portion containing at least one subregion of clinical interest and a second portion. The first portion is simplified without affecting clinically important information, and the second portion is simplified using a different scheme from that used with the first portion. The first portion is then compressed using a compression scheme having relatively low information loss and the second portion is compressed using a compression scheme having relatively high information loss.

To achieve these objects and in accordance with the purpose of the invention, a system and method are provided for reducing the amount of information contained in digital diagnostic images while preserving critical clinical information, the method in one embodiment comprising the steps of determining at least one region of interest located on the digital diagnostic images, compacting selected portions of information from the region of interest, decimating other selected portions from the digital diagnostic images, and coding non-decimated information by implementing a lossless coding algorithm.

The accompanying drawings, which are incorporated in and constitute a part of this specification, illustrate an embodiment of the invention and, together with the description, serve to explain the principles of the invention.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a flowchart illustrating clinically adaptive compression according to an embodiment of the invention.

FIG. 2 is a flowchart illustrating determining a region of interest according to an embodiment of the invention.

FIGS. 3, 4, and 5 are examples of images used with an embodiment of the present invention.

FIG. 3 is a sketch depicting a typical prenatal ultrasound image.

FIGS. 4 and 5 are sketches depicting typical echocardiography images.

FIG. 6 illustrates a schematic representation of a system for clinically adaptive compression according to an embodiment of the invention.

### DETAILED DESCRIPTION OF THE PREFERRED EMBODIMENT

Reference will now be made in detail to a preferred embodiment of the invention, an example of which is illustrated in the accompanying drawings in which like reference characters refer to corresponding elements.

This application discloses a novel method of reducing the size of digital medical images while preserving the most important clinical information. The method may be based upon a set of assumptions about the clinical significance of the image content that are used to identify and extract the clinical portion of the image from the non-clinical. The extracted clinical data may be further reduced in size by eliminating redundant data inserted into the image during construction by the medical imaging device. This redundancy may be spatial or temporal in nature. Application of industry standard coding algorithms further reduces the data size. The invention may be performed manually (e.g., by a doctor) or may be performed automatically via a module in a system.

Although the data compression is technically “lossy,” in that the processed image is not a pixel-for-pixel copy of the original, the method is effectively clinically lossless since only clinically redundant data is decimated or discarded. Compression ratios of 30:1 or more may be obtainable without loss of clinical image data, ratios of 100:1 or more may be achievable without discernible loss, and ratios of up to 400:1 or more may be achieved at a clinically acceptable level of degradation, dependent upon the clinical content.

In addition, the level of compression may be determined remotely by the reviewing physician so that the best compromise between transmission speed, bandwidth requirements, and diagnostic quality may be selected. The importance of this functionality is discussed in the co-pending provisional application by the same inventor entitled, “System and Method for Adaptive Transmission of Information”, U.S. Provisional Application No. 60/222,953.

Traditional image compression algorithms were designed for general purpose use and make no assumptions about the data they are compressing. For example, MPEG treats every video frame as unique, since it is not possible to predict the content of the next frame. The compression algorithm of this invention, however, makes assumptions about the image content and its clinical importance that significantly reduce the amount of data that has to be coded by the compressor. In effect, the algorithm pre-processes the image to reduce the entropy and improve its compressibility.

The assumptions may include those about the image content (e.g., ultrasound, angiography, x-ray etc.), about the manufacturer of the acquisition device (e.g., ATL, Siemens, G. E., etc.), and/or about whether the number of possible display layouts is limited and manufacturer-specific (e.g., linear, sector, scrolling, etc.). Additional assumptions may be made about the relative clinical importance of various regions of the displayed image such that clinically significant data is preferentially preserved.

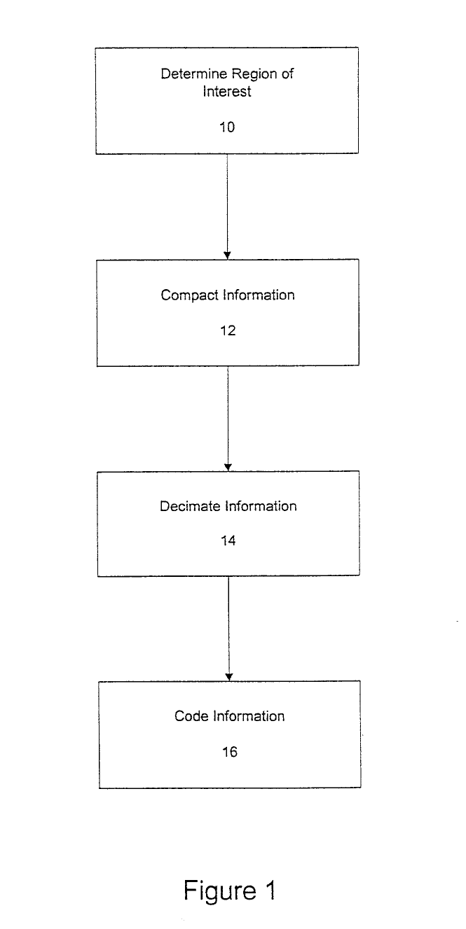

FIG. 1 is a flowchart illustrating the process for clinically adaptive compression according to an environment of the invention. At step 10, the region of interest is determined. Designated information is compacted at step 12, while other appropriate information is decimated at step 14. Information is then coded at step 16 and made available for viewing. This process will now be described in more detail below.

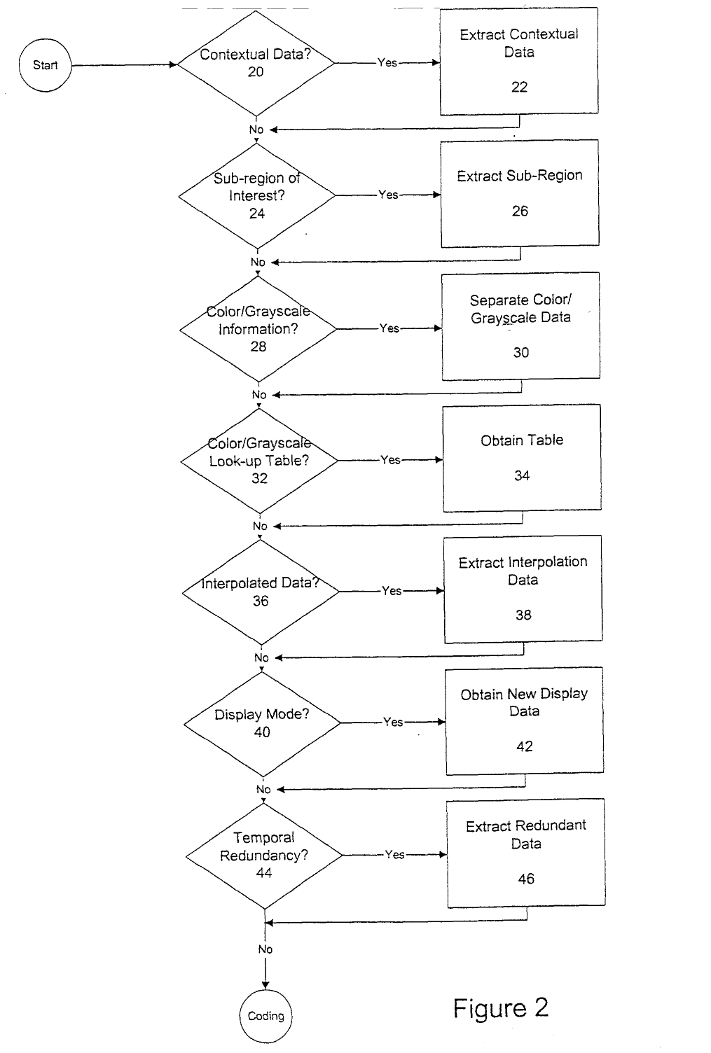

FIG. 2 is a flowchart illustrating a process for determining a region of interest and compacting and decimating information according to an embodiment of the invention. Although the flowchart illustrated in FIG. 2 describes the process being performed in a certain order of steps, it will be readily understood by a person of ordinary skill in the art that the steps may be performed in a different order, additional steps may added at one or more points in the process, and/or steps may be deleted from one or more points in the process.

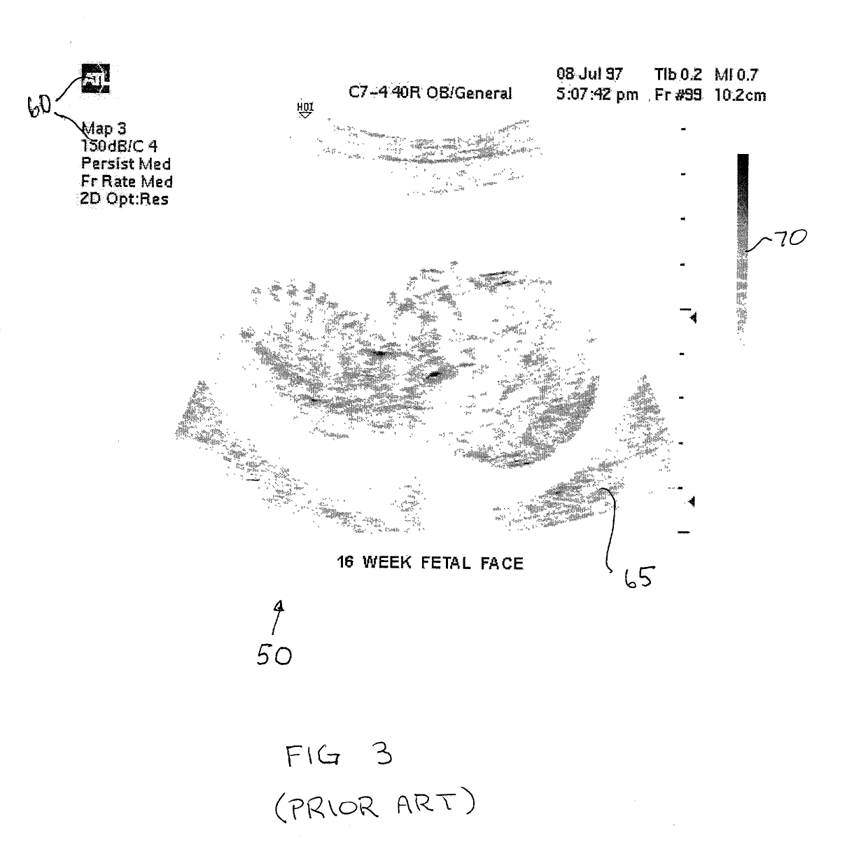

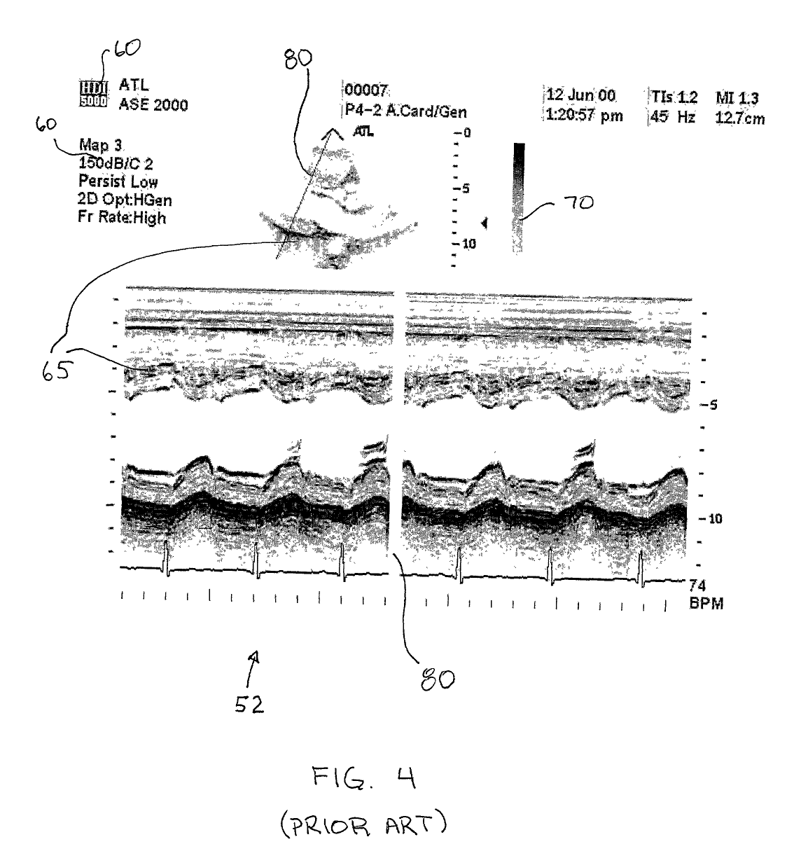

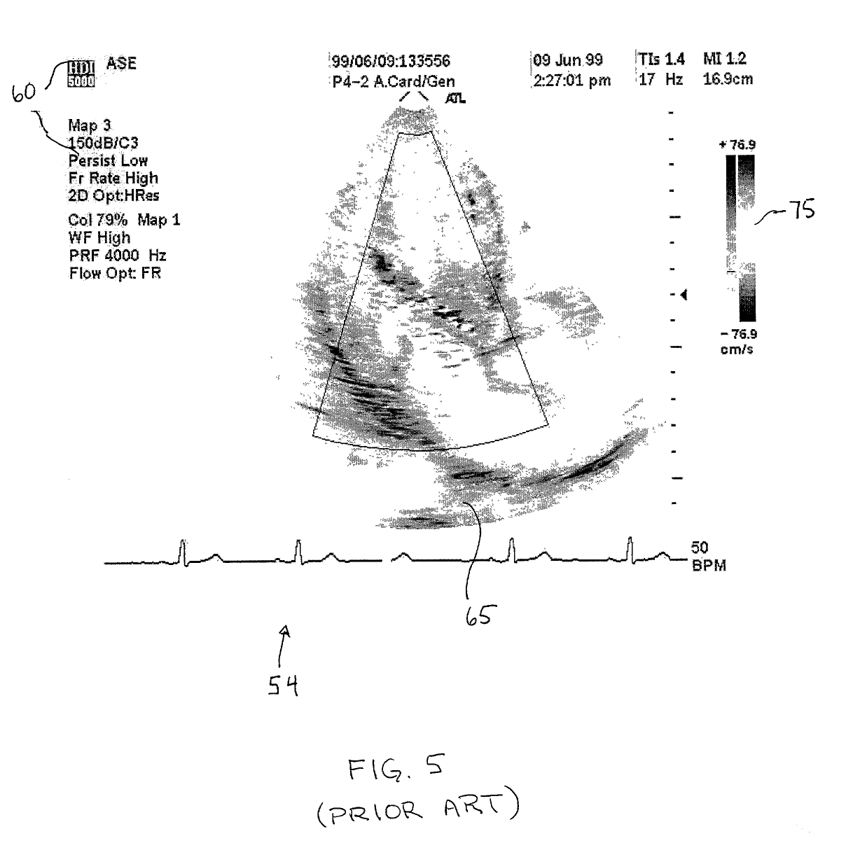

At step 20, the images are examined for contextual data. Digital image formats, whether acquired with a video frame grabber or directly from the acquisition system in a digital format, typically represent each image pixel with two bytes of data (16 bit) or three bytes of data (24 bit). This is necessary to adequately represent color graphics and text in the image or to allow for the digitization noise in the frame grabber. However, as little as 30% of the display area may contain clinical information, with the remainder usually occupied by contextual information (e.g, patient name, time of recording, etc.). Examples of contextual information 60 are illustrated on image 50 of FIG. 3, image 52 of FIG. 4, and image 54 of FIG. 5. These examples disclose what is being imaged (e.g., cardiogram), the time and date of the image, and other information. Other types of contextual information may also be present.

If contextual information is found, it can be extracted from the images at step 22. Extracting the clinical region of interest from the background may allow the contextual information to be coded with fewer bits without affecting clinical quality. When treated separately from the contextual information, the region of interest may also be coded with fewer bits, as discussed with respect to grayscale/color mapping below. In addition, the contextual information may be predominantly static from frame to frame and so only needs to be updated when the display layout changes, whereas the clinical region changes partially in every frame.

At step 24, the images are examined to determine if they contain a sub-region of interest. If a sub-region of interest is present, the sub-region is extracted at step 26. The clinical region of interest may contain sub-regions of data that may compress better when treated independently. For example, in color ultrasound images that depict blood flow, less than 50% of the clinical image area contains color information, yet clinically it is more important than the anatomical grayscale image used for localizing the blood flow. By way of example, the sub-region of interest 65, as illustrated in FIGS. 3-5, may be the portion of the image related to the portion of the patient being imaged (e.g., heart, lungs, blood vessels, uterus, etc.). Other sub-regions of interest, based on the image and the object being imaged, may also be used. At step 28, the images are examined for grayscale/color mapping information. If present, color information and grayscale information are separated at step 30. Separating color from grayscale data may allow greater compression of the less important anatomical data while preserving the full fidelity of the blood flow information.

In color Doppler mode, for example, each line of data takes much longer to acquire than the grayscale data (up to 5 times longer). As a consequence, there are fewer lines of data and the number of samples per lines is reduced, resulting in a lower resolution than that for grayscale. In addition, the sampling area for color Doppler is usually a small subset of the grayscale image area, in order to maintain the acquisition frame rate. Independent processing of color and grayscale allows for the preservation of the most important clinical characteristics while minimizing data size.

Depending upon the modality, image brightness may be represented as 8-, 12-, or 16-bit values. The entire range of possible values rarely occurs at one time in the image area because the imaging system applies some form of mapping or compression to enhance the clinically important data.

At step 32, the images are examined to determine if a grayscale/color look-up table is needed. If the look-up table is necessary, it is obtained at step 34. In general, dark areas and bright areas of the image are relatively unimportant from a clinical standpoint in that they are indicators of the absence of signal (black) or strong signal (white) and addition of subtle shades does not enhance visualization of these areas. However, the mid-tones are used to depict subtle differences in density between adjacent areas. For example, in ultrasound images, black is fluid, white is a strong reflector, such as bone, but tissue texture is depicted by soft gray shades. In angiograms, black is background, white is often calcium, an important clinical characteristic, and a narrowing of the vessels is seen in the soft gray shades. A typical gray map (e.g., a grayscale lookup table) would include black, white, and a selected range of gray shades dependent upon the application. As illustrated in FIGS. 3 and 4, by way of example only, a grayscale table 70 may be displayed near a sub-region of interest 65. Grayscale table 70 may assist a viewer in examining and evaluating the image.

A substantial improvement in compressibility may be achieved if the look-up table can be determined, because the total number of different values that have to be encoded by the compressor is reduced to just those in the table rather than the entire range of possible values.

The same mapping process may also be used for ultrasound color images. Internal to the ultrasound system, the data values used to generate the color image may be 8 bits or more, but the data is mapped through a look-up table to typically less than 64 discrete colors, and even as low as 32. By way of example, a color look-up table 75, as illustrated on image 54 of FIG. 5, may also be located near a sub-region of interest. The mapping process may be used for other types of images, including, but not limited to, standard x-rays and magnetic resonance imaging.

At step 36, the images are examined for information that can be interpolated. If such information is located, interpolated data is extracted from the images at step 38. For example, an ultrasound image is composed of a number of discrete scan lines representing the echo intensity along a given line of sight. However, these scan lines are not of uniform thickness and generally have spacing between them that results in under sampling. This under sampling would be seen in the image as black (no signal) spaces between the scan lines which is esthetically displeasing. To overcome this, the ultrasound system interpolates the missing data during the image construction process. In the case of radial scans (sector), the space between scan lines in the far field of the image is considerable. Since much of the image data is interpolated, it may be discarded during compression and re-interpolated during decompression with no loss of quality.

At step 40, the display mode of images is examined. For example, images using scrolling data, such as electrocardiograms (EKG), spectral Doppler, and M-Mode may be used with the present invention. Spectral Doppler depicts the frequency shift due to motion of blood cells through a selected sample volume and is typically displayed as a graph of frequency (or velocity) versus time. The gray shades in the display represent signal intensity at each frequency component. M-Mode represents the motion of anatomical structures along a single line of sight and is displayed as a graph of depth versus time. Each vertical column represents the position of the underlying anatomical structures at a given instant with gray shades representing the density of those structures. In these display modes of operation, a small black bar appears to sweep from left to right across the display area, with new data being written immediately to the left of the bar. By way of example only, a sweep bar 80 is illustrated on image 52 of FIG. 4. In effect, the only difference between frames is the position of the bar and the data to the left of it between the new position and the previous position. If this display mode is used for the images, the new display data is obtained at step 42. If just this small area is preserved for each frame rather than the entire display area, the quantity of data that must be coded during compression is considerably reduced.

At step 44, the images are examined for temporal redundancy. If temporal redundancy is found, the data is extracted at step 46. Unlike regular video frames, clinical image frames do not change radically from frame to frame. Typically, less than 30% of the clinical region of interest changes on a frame-by-frame basis and those changes are often small. Coding only the differences between frames can significantly reduce data redundancy and hence data size.

By way of one example of an embodiment of the invention, clinical adaptive compression may be performed on ultrasound images. As described above in reference to FIGS. 1 and 2, image compression according to one embodiment of the invention is accomplished in stages. These stages may comprise extracting the region of interest, data compaction, including elimination of redundancy, decimation of data, including decimation of spatial and/or temporal data, and coding data, including lossless coding of the compacted/decimated data.

Coding the image data immediately after the data compaction stage may result in clinically lossless compression. Although the image is no longer a pixel-for-pixel match with the original, compression is effectively lossless in that the clinical region of interest is not decimated and the original gray shades and color have been preserved. Additional lossy compression can be applied by increasing the decimation, with some visible loss of quality. Typically, there is a softening or blurring of the overall image due to the increasing amounts of interpolation required, but clinically important features are preserved.

As stated earlier, only a small portion of the display contains data (e.g., ultrasound image data) with the remainder being contextual information. The location and dimensions of the clinical region of interest are determined by the manufacturer and the operating mode of the imaging system. The region of interest may be identified using predefined parameters derived empirically from imaging systems from multiple manufacturers or dynamically by identification of key landmarks in the display. A combination of these methods may yield the best results in practice.

For example, grayscale data underlying a color Doppler image may be used as an anatomical reference for the location of the color flow data. Therefore, separating the color data from the grayscale data allows each data type to be sampled at different rates and thus preserve the clinical fidelity while maximizing the data reduction. The color area within the region of interest is determined by searching the region for color pixels.

Data compaction may include compacting reference frames, and compacting grayscale and color. An initial reference frame is generated that contains only the contextual data. This data can be adequately represented by 1 bit-per-pixel, thus reducing a 900 kilobytes color image to 38 kilobytes. During the data reduction, the ultrasound data may be masked by setting each image pixel to zero (black). The resulting data is very compressible since it contains mostly zero bytes. Industry standard, lossless compression of the data reduces the size further to about 6 kilobytes (150:1). As discussed earlier, the contextual information changes infrequently and only needs to be updated when the display layout changes.

Ultrasound images often contain a grayscale bar, which indicates the grayscale mapping used to represent the ultrasound data. This bar can be used to create a look-up table that contains the range of grayscale values in the clinical region of interest. Grayscale values encountered in the region of interest that do not exist in the look-up table are added to the table. If the bar does not exist, the region of interest itself is used to create the look up table. The number of discrete values in the look-up table can be further limited by varying the threshold at which values are considered different. Ultrasound images may also contain a color bar during some modes of operation that can be used to create a color look-up table, in a similar manner to that for grayscale.

The tables allow the region of interest to be coded as 8-bit indices to the 24-bit gray/color values contained in the look-up table and also to generate a color palette for correct rendition on the display. Although each pixel in the region of interest is coded as 8 bits, the number of discrete values encountered is typically less than 48 gray shades and 48 colors (when color data is present). This effectively reduces the entropy in the image and improves compressibility.

Data decimation may include decimation of spatial data and decimation of temporal data. Decimation of spatial data may comprise eliminating interpolated data. As discussed earlier, the clinical region of interest contains values that were calculated (interpolated) from the internal data when the image was generated. This calculated data can be eliminated and later recalculated prior to redisplay, without affecting the clinical quality.

Eliminating the interpolated data this way and using a bicubic re-sampling technique to re-interpolate it allows considerable data reduction with minimum visible loss. Bi-cubic re-sampling is commonly used in image processing applications. Experiment has shown that decimation of the ultrasound image by a factor of 3 horizontally and a factor of 2 vertically (3×2) reduces the data size by a factor of 6 without appreciable loss of clinical quality.

Decimating temporal data may include frame differencing, frame averaging and/or interleaving. Decimating temporal data by frame differencing may include using the first frame as a reference, subsequent frames of data are subtracted from each other, or the reference and the difference values losslessly compressed. This pre-differencing enhances compression by coding repetitive estimates as zero. Frames are reconstituted by adding the difference values to the values of either the reference frame or the previous frame.

Alternatively, decimating temporal data by frame averaging may comprise discarding intermediate frames and later restoring these frames by interpolation of data from adjacent frames. This method works well for digitized video since the video frame rate may be higher than the acquisition frame rate of the medical imaging device, leading to redundant video frames.

Decimating temporal data by interleaving may comprise sampling even columns in one frame and odd columns in the next to achieve further data reduction of 2:1. When the columns are recombined prior to display, the original spatial resolution is restored but at a lower apparent frame rate and with some flicker.

The application of an industry standard lossless coding method, such as Huffman coding, results in a further compression of the data. The final compression rate achieved varies from frame to frame, dependent upon content, but is typically (3.5:1). Other coding methods, such as fractal or wavelet could also be used.

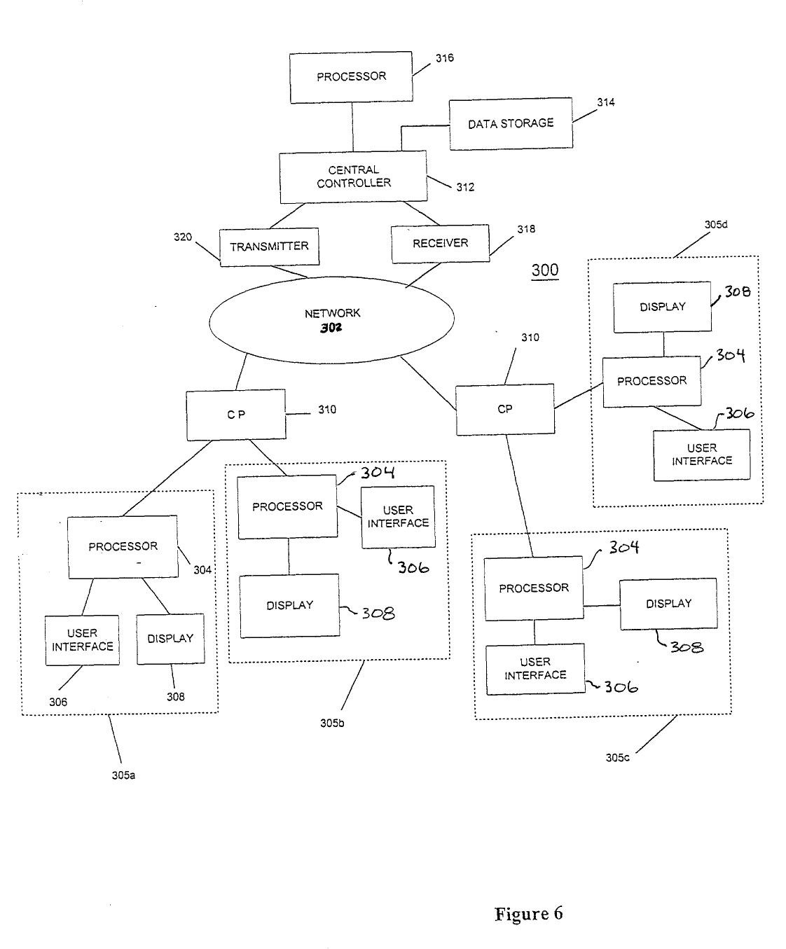

FIG. 6 illustrates a system 300 according to an embodiment of the present invention. The system 300 comprises multiple requester devices or computers 305 used to connect to a network 302 through multiple connector providers (CPs) 210. The network 302 may be any network that permits multiple requesters or computers to connect and interact.

According to an embodiment of the invention, the network 302 may be, include or interface to any one or more of, for instance, the Internet, an intranet, a personal area network, a local area network, a wide area network, a metropolitan area network, a storage area network, a frame relay connection, an Advanced Intelligent Network connection, a synchronous optical network (SONET) connection, a digital T1, T3, E1, or E3 line, Digital Data Service connection, DSL connection, an Ethernet connection, an ISDN (Integrated Services Digital Network) line, a dial-up port such as a V.90, V.34 or V.34 bis analog modem connection, a cable modem, an asynchronous transfer mode connection, a Fiber Distributed Data Interface or Copper Distributed Data Interface connection.

The network 302 may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a global positioning system link, cellular digital packet data, a RIM (Research in Motion, Limited) duplex paging type device, a Bluetooth™ radio link, or an IEEE 802.11-based radio frequency link. The network 302 may yet further be, include or interface to any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection. The CP 310 may be a provider that connects the requesters to the network 302. For example, the CP 310 may be an Internet service provider, a dial-up access means such as a modem, or other manner of connecting to the network 302. In actual practice, there may be significantly more users connected to the system 300 than shown in FIG. 5. For purposes of illustration, this disclosure describes a system 300 having four requester devices 305 that are connected to the network 302 through two CPs 310.

According to an embodiment of the invention, the requester devices 305a-305d may each make use of any device (e.g., computer, wireless telephone, personal digital assistant, etc.) capable of accessing the network 302 through a CP 310. Alternatively, some or all of the requester devices 305a-305d may access the network 302 through a direct connection, such as a T1 line or similar connection. FIG. 6 shows four requester devices 305a-305d, each having a connection to the network 302 through a CP 310. The requester devices 305a-305d may each make use of a personal computer, such as a remote computer, or may use other devices, which allow the requester to access and interact with others on the network 302. A central controller module 312 may also have a connection to the network 302 as described above. The central controller module 312 may communicate with one or more data storage modules 314, the latter being discussed in more detail below.

Each requester device 305a-305d used may contain a processor module 304, a display module 308, and a user interface module 306. Each requestor device 305a-305d may have at least one user interface module 306 for interacting and controlling the computer. The user interface module 306 may have one or more of a keyboard, a joystick, a touchpad, a mouse, a scanner or any similar input device or combination of devices. Each of the computers 305a-305d used by the requester devices 305a-305d may also include a display module 308, such as a CRT display or other device.

The requester device 305 may be or include, for instance, a personal computer running any suitable operating system or platform. The requester device 305 may typically include a microprocessor, electronic memory such as RAM (random access memory) or EPROM (electronically programmable read only memory), storage such as a hard drive, CD-ROM or rewriteable CD-ROM or other magnetic, optical or other media, and other associated components connected over an electronic bus, as will be appreciated by persons skilled in the art. The requester device 305 may also be or include any suitably network-enabled appliance.

As discussed above, the system 300 includes a central controller module 312. The central controller module 312 may maintain a connection to the network 302 such as through a transmitter module 318 and a receiver module 320. The transmitter module 318 and receiver module 320 may be comprised of conventional devices that enable the central controller module 312 to interact with the network 302. According to an embodiment of the invention, the transmitter module 318 and the receiver module 320 may be integral with the central controller module 312. The connection to the network 302 by the central controller module 312 and requester device 305 may be a high speed, large bandwidth connection, such as though a Ti or a T3 line, a cable connection, a telephone line connection, a DSL connection, or other type of connection. The central controller module 312 functions to permit the requester devices 305a-305d to interact with each other in connection with various applications, messaging services and other services which may be provided through the system 300.

The central controller module 312 preferably comprises either a single server computer or a plurality of multiple server computers configured to appear to requester devices 305a-305d as a single resource. The central controller module 312 communicates with a number of data storage modules 314.

Each data storage module 314 stores digital files, including images. According to an embodiment of the invention, any data storage module 314 may be located on one or more data storage devices, where the data storage devices are combined or separate from the central controller module 312. The processor module 316 performs the various processing functions required in the practice of the process taught by the present invention, such as determining the region of interest, compacting information, examining images, decimating information coding information and other processing. The processor module 316 may be comprised of a standard processor, such as a central processing unit, which is capable of processing the information in the necessary manner.

While the system 300 of FIG. 6 discloses a requester device 305 connected to the network 302, it is understood that a personal digital assistant (“PDA”), a mobile telephone, a television, or another device that permits access to the network 302 may be used to arrive at the system of the present invention.

According to another embodiment of the invention, a computer-usable and writeable medium having a plurality of computer readable program code stored therein may be provided for practicing the method of the present invention. The process and system of the present invention may be implemented utilizing any suitable operating systems or platform. Network enabled code may be, include, or interface to, for example, Hyper Text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C⁺⁺, Perl, UNIX Shell, Visual Basic or Visual Basic Script, Virtual Reality Markup Language (VRML), ColdFusion™, or other compilers, assemblers, interpreters or other computer languages or platforms. For example, the computer-usable medium may be comprised of a CD-ROM, a floppy disk, a hard disk, or any other computer-usable medium. One or more of the components of the system 300 may comprise computer readable program code in the form of functional instructions stored in the computer-usable medium such that when the computer-usable medium is installed on the system 300, those components cause the system 300 to perform the functions described. The software for the present invention may also be bundled with other software. For example, if another software company has a product that generates a lot of files that needs to be deleted periodically, they could add the code for implementing the present invention directly into their program.

According to one embodiment, the central controller module 312, the data storage 314, the processor module 316, the receiver module 318, and the transmitter module 320 may comprise computer-readable code that, when installed on a computer, perform the functions described above. Also, only some of the components may be provided in computer-readable code.

Additionally, various entities and combinations of entities may employ a computer to implement the components performing the above described functions. According to an embodiment of the invention, the computer may be a standard computer comprising an input device, an output device, a processor device, and data storage device. According to other embodiments of the invention, various components may be different department computers within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, a system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein.

The specification and examples should be considered exemplary only. The intended scope of the invention is only limited by the claims appended hereto.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method of compressing clinical image data generated by a device, the method comprising:
identifying a subregion of interest in the clinical image data;
separating the clinical image into a first portion comprising the subregion of interest and a second portion comprising the clinical image data not in the subregion of interest;
compressing the first portion of the image using a first compression scheme having relatively low information loss and a relatively low compression ratio; and
compressing the second portion of the image using a second compression scheme having relatively higher data information loss and a relatively higher compression ratio.

2. The method of claim 1, wherein the first compression scheme has no information loss.

3. The method of claim 1, wherein at least the second compression scheme includes decimation of the second portion of the clinical image data.

4. The method of claim 1, wherein the clinical image data comprises a plurality of ultrasonic images.

5. The method of claim 1, wherein the clinical image data comprises a plurality of echocardiography images.

6. The method of claim 1, further comprising the step of combining the compressed first and second portions of the clinical image data.

7. The method of claim 6, further comprising the step of further compressing the combined compressed clinical image data.

8. The method of claim 1, wherein the subregion of interest is determined using data about the device that generated the image data.

9. A method of compressing clinical image data generated by a device, the method comprising:
identifying a subregion of interest in the clinical image data;
separating the clinical image into a first portion comprising the subregion of interest and a second portion comprising the clinical image data not in the subregion of interest;
compressing the second portion of the image using a second compression scheme having relatively higher data information loss and a relatively higher compression ratio;
simplifying the data first portion without reducing the clinically important information in the first data portion;
compressing the simplified data first portion using a first compression scheme having relatively low data information loss and relatively high compression ratio; and
combining the compressed first and second portions of the clinical image data.

10. The method of claim 9, wherein the first compression scheme has no information loss.

11. The method of claim 9, wherein at least the second compression scheme includes decimation of the second portion of the clinical image data.

12. The method of claim 9, wherein the clinical image data comprises a plurality of ultrasonic images.

13. The method of claim 9, wherein the clinical image data comprises a plurality of echocardiography images.

14. The method of claim 9, further comprising the step of further compressing the combined compressed clinical image data.

15. The method of claim 9, wherein the subregion of interest is determined using data about the device that generated the image data.

16. The method of claim 9, wherein the data first portion is simplified by removing interpolated data.

17. The method of claim 9, wherein the data first portion is simplified by reducing the number of image shade values to only include values that are clinically relevant.

18. The method of claim 9, wherein the data first portion is simplified by extracting redundant data.

19. A method of compressing clinical image data generated by a device, the method comprising:
identifying at least one subregion of clinical interest in the clinical image data;
separating the clinical image into a first portion comprising the subregion of interest and a second portion comprising the clinical image data not in the subregion of interest;
simplifying the first portion of the image using a first scheme that uses various assumptions about the first portion to identify and eliminate redundant data and increase compressibility without affecting clinically important information;
simplifying the second portion of the image using a second scheme using different assumptions than that for the first portion to identify and eliminate redundant data and increase compressibility;
compressing the simplified data of the first portion of the image using a first compression scheme having relatively low information loss; and
compressing the second portion of the image using a second compression scheme having relatively higher information loss.

20. The method of claim 19, wherein the first compression scheme has no information loss.

21. The method of claim 19, wherein the subregions of interest are determined using data about the device that generated the image data.

22. The method of claim 19, wherein the data first portion is simplified by removing interpolated data added by the device that generated the image data.

23. The method of claim 19, wherein the data first portion is simplified by reducing the number of image color values to only include values that are clinically relevant.

24. The method of claim 19, wherein at least the first compression scheme includes spatial domain decimation of the clinical image data.

25. The method of claim 19, wherein at least the first compression scheme includes frequency domain decimation of the clinical image data.

26. The method of claim 19, wherein the clinical image data comprises a plurality of ultrasonic images.

27. The method of claim 26, wherein the plurality of ultrasonic images are examined to identify and eliminate data that occurs in more than one image.

28. The method of claim 19, further comprising the step of combining the compressed first and second portions of the clinical image data.

29. The method of claim 28, further comprising the step of further compressing the combined compressed clinical image data.
